(19) United States
(12) Patent Application Publication
(10) Pub. No.: US 2003/0040925 A1
(43) Pub. Date: Feb. 27, 2003

(54) Vision-based method and apparatus for detecting fraudulent events in a retail environment

(75) Inventors: Srinivas Gutta, Buchanan, NY (US); Miroslav Trajkovic, Ossining, NY (US); Antonio Colmenarez, Peekskill, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/938,148

(22) Filed: Aug. 22, 2001

(51) Int. Cl. G06F 17/60

(52) U.S. Cl. 705/1

(57) ABSTRACT

A method and apparatus are disclosed for monitoring a retail location using vision-based technologies to recognize predefined fraudulent events. Captured images are processed to identify one or more predefined fraudulent events and to initiate an appropriate response, such as sending notice to an employee for further investigation or recording the event for evidentiary purposes. A number of rules define various fraudulent events. For example, rules can be devised to detect when a patron is wearing stolen clothing out of the changing room, or when a patron is fraudulently attempting to return merchandise without a receipt. Each rule contains one or more conditions that must be satisfied and a corresponding action-item that should be performed when the rule is satisfied. At least one of the conditions for each rule identifies a feature that must be detected in an image using vision-based techniques. An event monitoring process is also disclosed that analyzes the captured images to detect one or more fraudulent events defined by the event rules.

### FIELD OF THE INVENTION

The present invention relates to computer-vision techniques, and more particularly, to a method and apparatus for detecting fraudulent events in a retail environment.

### BACKGROUND OF THE INVENTION

Due to increasing labor costs, as well as an inadequate number of qualified employee candidates, many retail businesses and other establishments must often operate with an insufficient number of employees. Thus, when there are not enough employees to perform every desired function, the management must prioritize responsibilities to ensure that the most important functions are satisfied, or find an alternate way to perform the function. For example, many retail establishments utilize automated theft detection systems to replace or supplement a security staff.

In addition, many businesses do not have enough employees to adequately monitor an entire store or other location, for example, for security purposes. Thus, many businesses and other establishments position cameras at various locations to monitor the activities of patrons and employees. While the images generated by the cameras typically allow the various locations to be monitored by one person positioned at a central location, such a system nonetheless requires human monitoring to detect events of interest.

Retail stores lose a significant portion of revenue annually due to fraudulent behavior, such as stolen merchandise or fraudulent returns. For example, it is not uncommon for an individual to enter a store, pick up an item, pretend that they have previously purchased the item and then attempt to return the item without a receipt. It is impractical, if not impossible, for a retailer to monitor the behavior of every customer that enters a given store.

In addition, due to the competitive nature of the retail environment, most retailers are forced to maintain relatively liberal return policies that allow merchandise to be returned without a receipt under certain conditions. Thus, retailers have been unable to effectively prevent or even discourage such fraudulent merchandise returns. A need therefore exists for a monitoring system that uses vision-based technologies to automatically recognize fraudulent events in a retail environment. A further need exists for an event monitoring system that employs a rule-base to define each fraudulent event.

### SUMMARY OF THE INVENTION

Generally, a method and apparatus are disclosed for monitoring a location using vision-based technologies to recognize predefined fraudulent events in a retail environment. The disclosed event monitoring system includes one or more image capture devices that are focused on a given retail location. The captured images are processed by the event monitoring system to identify one or more fraudulent events and to initiate an appropriate response, such as sending a notification to an employee.

According to one aspect of the invention, a number of rules are utilized to define various fraudulent events. For example, rules can be devised in accordance with the present invention to detect when a patron is wearing stolen clothing out of the changing room, or when a patron is fraudulently attempting to return merchandise without a receipt. Each rule contains one or more conditions that must be satisfied in order for the rule to be triggered, and, optionally, a corresponding action-item that should be performed when the rule is satisfied, such as sending a notification to an employee. At least one condition for each rule identifies a feature that must be detected in an image using vision-based techniques. Upon detection of a predefined event, the corresponding action, if any, is performed by the event monitoring system.

A more complete understanding of the present invention, as well as further features and advantages of the present invention, will be obtained by reference to the following detailed description and drawings.

### BRIEF DESCRIPTION OF THE DRAWINGS

FIG. 1 illustrates an event monitoring system in accordance with the present invention;

FIG. 2 illustrates a sample table from the event database of FIG. 1;

FIG. 3 is a flow chart describing an exemplary event monitoring process embodying principles of the present invention; and

FIG. 4 is a flow chart describing an exemplary fraudulent merchandise return detection process incorporating features of the present invention.

### DETAILED DESCRIPTION

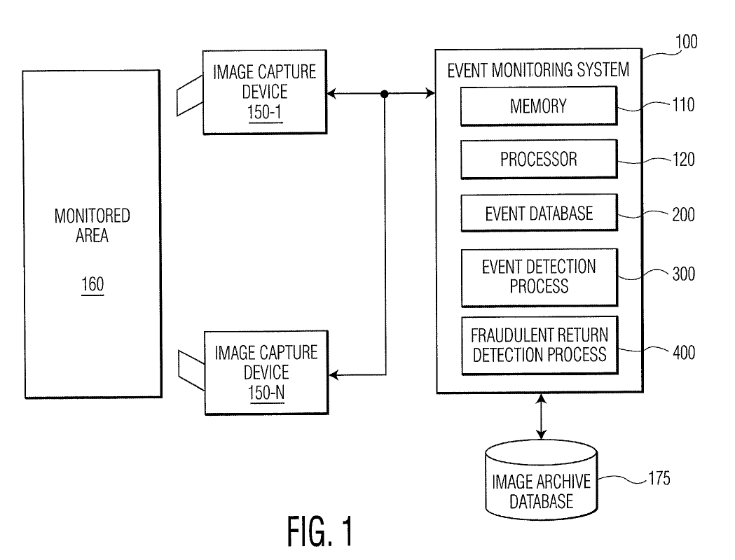

FIG. 1 illustrates an event monitoring system 100 in accordance with the present invention. Generally, the events detected by the present invention are fraudulent events in a retail environment, such as stealing merchandise or attempting to return merchandise that has not been purchased, hereinafter collectively referred to as “fraudulent events.” As shown in FIG. 1, the event monitoring system 100 includes one or more image capture devices 150-1 through 150-N (hereinafter, collectively referred to as image capture devices 150) that are focused on one or more monitored areas 160. The monitored area 160 can be any location that is likely to have a fraudulent event, such as one or more entrances, exits, aisles, return counters, access areas for changing rooms, or display areas in a store.

The present invention recognizes that fraudulent events are often subsequently involved in a criminal trial. Thus, according to another aspect of the invention, the images captured by the image capture devices 150 may be recorded and stored for evidentiary purposes, for example, in an image archive database 175. As discussed further below, images associated with each detected fraudulent event may optionally be recorded in the image archive database 175 for evidentiary purposes. In one embodiment, a predefined number of image frames before and after each detected fraudulent event may be recorded in the image archive database 175, together with a time-stamp of the event, for example, for evidentiary purposes.

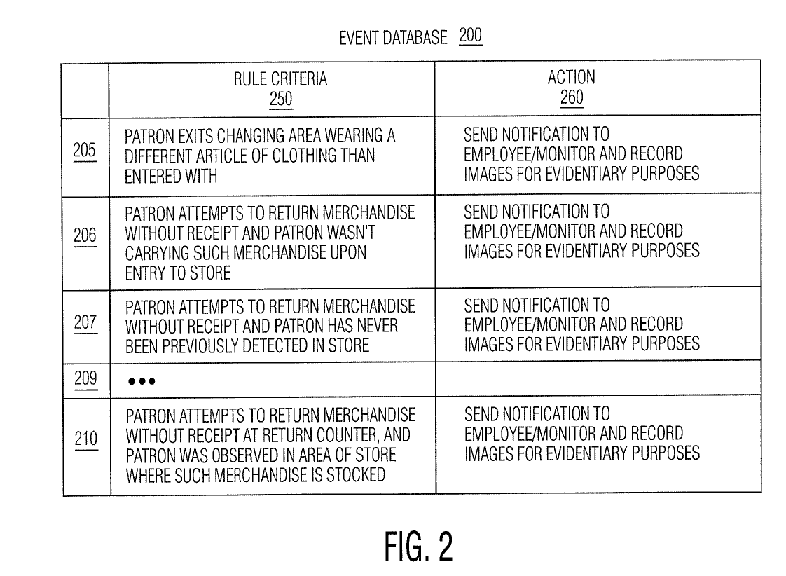

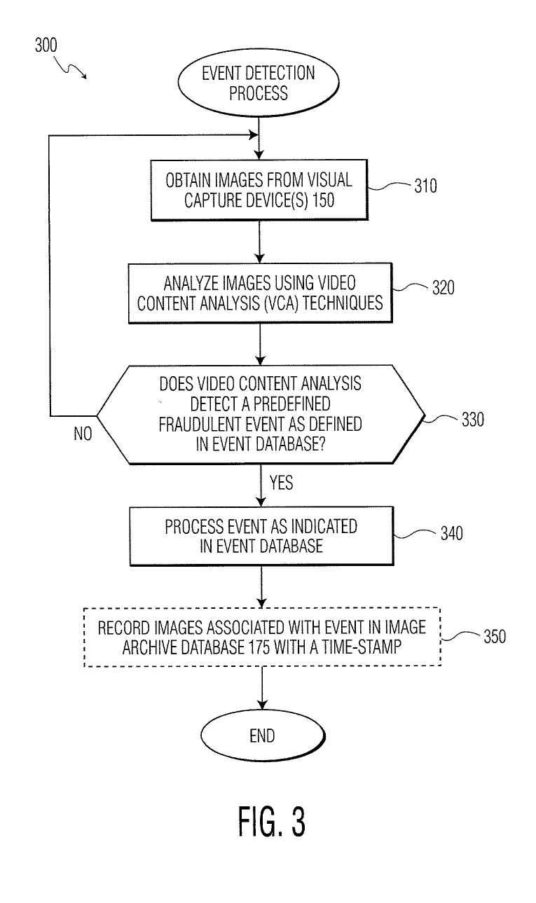

Each image capture device 150 may be embodied, for example, as a fixed or pan-tilt-zoom (PTZ) camera for capturing image or video information. The images generated by the image capture devices 150 are processed by the event monitoring system 100, in a manner discussed below in conjunction with FIG. 3, to identify one or more predefined fraudulent events. In one implementation, the present invention employs an event database 200, discussed further below in conjunction with FIG. 2, that records a number of rules defining various fraudulent events.

The fraudulent events defined by each rule may be detected by the event monitoring system 100 in accordance with the present invention. As discussed further below, each rule contains one or more criteria that must be satisfied in order for the rule to be triggered, and, optionally, a corresponding action-item that should be performed when the predefined criteria for initiating the rule is satisfied. At least one of the criteria for each rule is a condition detected in an image using vision-based techniques, in accordance with the present invention. Upon detection of such a predefined fraudulent event, the corresponding action, if any, is performed by the event monitoring system 100, such as sending a notification to an employee or recording the event for evidentiary purposes (or both).

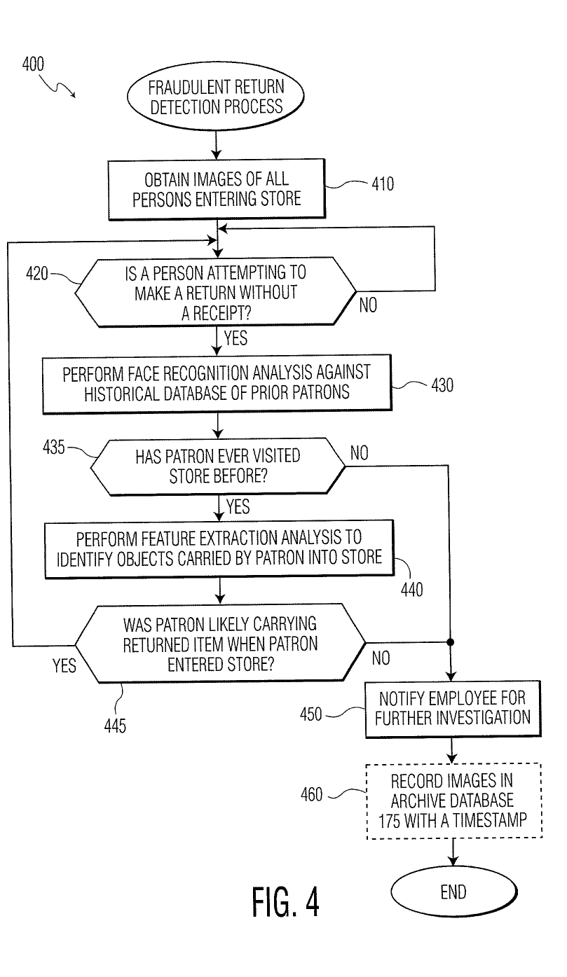

As shown in FIG. 1, and discussed further below in conjunction with FIGS. 3 and 4, the event monitoring system 100 also contains an event detection process 300 and a fraudulent return detection process 400. Generally, the event detection process 300 analyzes the images obtained by the image capture devices 150 and detects a number of specific, yet exemplary, fraudulent events defined in the event database 200. The fraudulent return detection process 400 analyzes the images obtained by the image capture devices 150 and detects when a person is attempting to make a fraudulent merchandise return.

The event monitoring system 100 may be embodied as any computing device, such as a personal computer or workstation, that contains a processor 120, such as a central processing unit (CPU), and memory 110, such as RAM and/or ROM. In an alternate implementation, the image processing system 100 may be embodied using an application specific integrated circuit (ASIC).

FIG. 2 illustrates an exemplary table of the event database 200 that records each of the rules that define various fraudulent events. Each rule in the event database 200 includes predefined criteria specifying the conditions under which the rule should be initiated, and, optionally, a corresponding action item that should be triggered when the criteria associated with the rule is satisfied. Typically, the action item defines one or more appropriate step(s) that should be performed when the rule is triggered, such as sending notification to an appropriate employee or recording the event for evidentiary purposes (or both).

As shown in FIG. 2, the exemplary event database 200 maintains a plurality of records, such as records 205-210, each associated with a different rule. For each rule, the event database 200 identifies the rule criteria in field 250 and the corresponding action item, if any, in field 260.

For example, the rule recorded in record 205 is an event corresponding to a patron attempting to steal merchandise by wearing clothing that has not been purchased out of the changing room. As indicated in field 250, the rule in record 205 is triggered when the patron leaves the changing area with different clothing than the patron wore into the changing area. As indicated in field 260, the corresponding action consists of sending notification to an employee or monitor of the changing area and recording the event for evidentiary purposes.

The fraudulent event defined in record 205 may be detected, for example, by capturing an image of each patron that enters the store or enters the changing area and extracting descriptors identifying the clothing worn by the patron into the store. Thereafter, the descriptors extracted upon entry to the store or changing area can be compared to descriptors extracted when the patron leaves the changing area. If the descriptors are significantly different, an alarm is sent to an employee for further investigation. For a detailed discussion of a suitable feature extraction technique, see, for example, U.S. patent application Ser. No. 09/703,423, filed Nov. 11, 2000, entitled “Person Tagging in an Image Processing System Utilizing a Statistical Model Based on Both Appearance and Geometric Features,” assigned to the assignee of the present invention and incorporated by reference herein.

Likewise, the rules recorded in records 206, 207 and 210 define events corresponding to a patron attempting to return merchandise without a receipt. As indicated in field 250, the rules in record 206, 207 and 210 are triggered when the patron attempts to return merchandise without a receipt and one or more additional conditions (specified in each rule) are satisfied. As indicated in field 260, the corresponding action consists of sending notification to an employee or monitor and recording the event for evidentiary purposes.

The fraudulent event defined in record 206 may be detected, for example, by capturing an image of each patron that enters the store and determining if the patron was carrying the merchandise now being returned when the patron entered the store, using the feature extraction techniques referenced above. The fraudulent event defined in record 207 may be detected, for example, by capturing an image of each patron that enters the store and using face recognition techniques to determine if the image corresponds to a patron that has previously entered the store. This rule assumes that if the person has not previously been in the store, it is unlikely that the item was purchased on a previous visit. The fraudulent event defined in record 210 may be detected, for example, by monitoring key areas of the store and determining if the patron was recently present in the area of the store where the returned merchandise is stocked, using face recognition techniques.

For a detailed discussion of suitable face recognition techniques, see, for example, A. Colmenarez and T. S. Huang, “Maximum Likelihood Face Detection,” Int'l Conf' on Automatic Face and Gesture Recognition (IEEE, 1996) and S. Gutta et al. “Face and Hand Gesture Recognition Using Hybrid Classifiers,” Int'l Conf' on Automatic Face and Gesture Recognition (IEEE, 1996), each incorporated by reference herein.

FIG. 3 is a flow chart describing an exemplary event detection process 300. The event detection process 300 analyzes images obtained from the image capture devices 150 and detects a number of specific, yet exemplary, fraudulent events defined in the event database 200. As shown in FIG. 3, the event detection process 300 initially obtains one or more images of the monitored area 160 from the image capture devices 150 during step 310.

Thereafter, the images are analyzed during step 320 using video content analysis (VCA) techniques. For a detailed discussion of suitable VCA techniques, see, for example, Nathanael Rota and Monique Thonnat, “Video Sequence Interpretation for Visual Surveillance,” in Proc. of the 3d IEEE Int'l Workshop on Visual Surveillance, 59-67, Dublin, Ireland (Jul. 1, 2000), and Jonathan Owens and Andrew Hunter, “Application of the Self-Organizing Map to Trajectory Classification,” in Proc. of the 3d IEEE Int'l Workshop on Visual Surveillance, 77-83, Dublin, Ireland (Jul. 1, 2000), incorporated by reference herein. Generally, the VCA techniques are employed to recognize various features in the images obtained by the image capture devices 150.

A test is performed during step 330 to determine if the video content analysis detects a predefined event, as defined in the event database 200. If it is determined during step 330 that the video content analysis does not detect a predefined event, then program control returns to step 310 to continue monitoring the location(s) 160 in the manner discussed above.

If, however, it is determined during step 330 that the video content analysis detects a predefined event, then the event is processed during step 340 as indicated in field 260 of the event database 200. As previously indicated, according to one aspect of the invention, the images associated with a detected fraudulent event may optionally be recorded in the image archive database 175, with a time-stamp for evidentiary purposes during step 350. Program control then terminates (or returns to step 310 and continues monitoring location(s) 160 in the manner discussed above).

As previously indicated, the fraudulent return detection process 400 analyzes the images obtained by the image capture devices 150 and detects when a person is attempting to make a fraudulent merchandise return. The exemplary embodiment shown in FIG. 4 monitors for the fraudulent events defined in records 206 and 207 of the event database 200. As shown in FIG. 4, the fraudulent return detection process 400 initially obtains one or more images of each patron entering a given store during step 410.

A test is performed during step 420 to determine if a person is attempting to return merchandise without a receipt. Once it is determined during step 420 that a person is attempting to return merchandise without a receipt, program control proceeds to step 430.

A face recognition analysis is performed during step 430 against a historical image database of those patrons who have previously entered the store. A test is performed during step 435 to determine if the patron attempting to make the return has ever entered the store before. Generally, if the patron has not previously been detected in the store, then there is a good chance that the patron did not legitimately purchase the returned item on a prior visit. If it is determined during step 435 that the patron attempting to make the return has entered the store before, the fraudulent event defined by record 207 has not been triggered and program control proceeds to step 440.

If, however, it is determined during step 435 that the patron attempting to make the return has never entered the store before, then it is possible that this patron never purchased the merchandise, and a notification is sent to an employee during step 450 for further investigation. In addition, as previously indicated, according to one aspect of the invention, the images associated with a detected fraudulent event may optionally be recorded in the image archive database 175, with a time-stamp for evidentiary purposes during step 460. Program control then terminates (or returns to step 420 and continues monitoring for potential fraudulent events in the manner discussed above).

A feature extraction analysis is performed during step 440 to identify objects that may have been carried by the patron into the store. A test is performed during step 445 to determine if the patron was likely carrying the returned merchandise when the patron entered the store. If it is determined during step 445 that the patron was not carrying the returned merchandise when the patron entered the store, then program control proceeds to step 450 for further investigation and continues in the manner described above.

If, however, it is determined during step 445 that the patron was likely carrying the returned merchandise when the patron entered the store, then the fraudulent event defined by record 206 has not been triggered and program control returns to step 420 to continue monitoring for further fraudulent events.

It is to be understood that the embodiments and variations shown and described herein are merely illustrative of the principles of this invention and that various modifications may be implemented by those skilled in the art without departing from the scope and spirit of the invention.

What is claimed is:

1. A method for detecting a fraudulent event in a retail location, comprising:
establishing a rule defining said fraudulent event, said rule including at least one condition;
processing at least one image of said retail location to identify said condition; and
performing a defined action if said rule is satisfied.

2. The method of claim 1, further comprising the step of recording said at least one image if said rule is satisfied.

3. The method of claim 1, wherein said fraudulent event is a person stealing an item.

4. The method of claim 1, wherein said fraudulent event is a person attempting to return an item without a receipt.

5. The method of claim 4, wherein said person attempting to return an item without a receipt has not previously been detected in said retail location.

6. The method of claim 4, wherein said person attempting to return an item without a receipt has been detected in an area of said retail location where said item is stocked.

7. The method of claim 4, wherein said person attempting to return an item without a receipt was not carrying said item when said person entered said retail location.

8. The method of claim 1, wherein said processing step further comprises the step of performing a face recognition analysis on said image.

9. The method of claim 1, wherein said processing step further comprises the step of performing a feature extraction analysis on said image.

10. A method for detecting a fraudulent event at a retail location, comprising:
obtaining at least one image of said retail location;
analyzing said image using video content analysis techniques to identify at least one predefined feature in said image associated with said fraudulent event; and
performing a defined action if said rule is satisfied.

11. The method of claim 10, wherein said fraudulent event is a person stealing an item.

12. The method of claim 10, wherein said fraudulent event is a person attempting to return an item without a receipt.

13. A system for detecting a fraudulent event in a retail location, comprising:
a memory that stores computer-readable code; and
a processor operatively coupled to said memory, said processor configured to implement said computer-readable code, said computer-readable code configured to:
establish a rule defining said fraudulent event, said rule including at least one condition;
process at least one image of said retail location to identify said condition; and
perform a defined action if said rule is satisfied.

14. The system of claim 13, wherein said fraudulent event is a person stealing an item.

15. The system of claim 13, wherein said fraudulent event is a person attempting to return an item without a receipt.

16. A system for detecting a fraudulent event in a retail location, comprising:
a memory that stores computer-readable code; and
a processor operatively coupled to said memory, said processor configured to implement said computer-readable code, said computer-readable code configured to:
obtain at least one image of said retail location;
analyze said image using video content analysis techniques to identify at least one predefined feature in said image associated with said fraudulent event; and
perform a defined action if said rule is satisfied.

17. The system of claim 16, wherein said fraudulent event is a person stealing an item.

18. The system of claim 16, wherein said fraudulent event is a person attempting to return an item without a receipt.

19. An article of manufacture for detecting a fraudulent event in a retail location, comprising:
a computer readable medium having computer readable code means embodied thereon, said computer readable program code means comprising:
a step to establish a rule defining said fraudulent event, said rule including at least one condition;
a step to process at least one image of said retail location to identify said condition; and
a step to perform a defined action if said rule is satisfied.

20. An article of manufacture for detecting a fraudulent event in a retail location, comprising:
a computer readable medium having computer readable code means embodied thereon, said computer readable program code means comprising:
a step to obtain at least one image of said retail location;
a step to analyze said image using video content analysis techniques to identify at least one predefined feature in said image associated with said fraudulent event; and
a step to perform a defined action if said rule is satisfied.
